(19) United States
(12) Patent Application Publication
(10) Pub. No.: US 2003/0227155 A1
(43) Pub. Date: Dec. 11, 2003

(54) Skascooter

(76) Inventor: Jasper Lee Walker, Jersey City, NJ (US)

Correspondence Address: JASPER L. WALKER, 1991 Kennedy Bldv., Jersey City, NJ, 07305, US

(21) Appl. No.: 10/119,488

(22) Filed: Jun. 6, 2002

(51) Int. Cl. B62K 5/00

(52) U.S. Cl. 280/282

(57) ABSTRACT

It would include a functional seat as well as a pedal mechanism, thus providing the rider with an option to constant standing and propelling the scooter with one foot. This would provide added flexibility to the design, thus making it ideal for individuals of all ages. The sturdy tip resistant design of the device could make it ideal for senior citizens who want to remain active and fit, but need to rest occasionally.

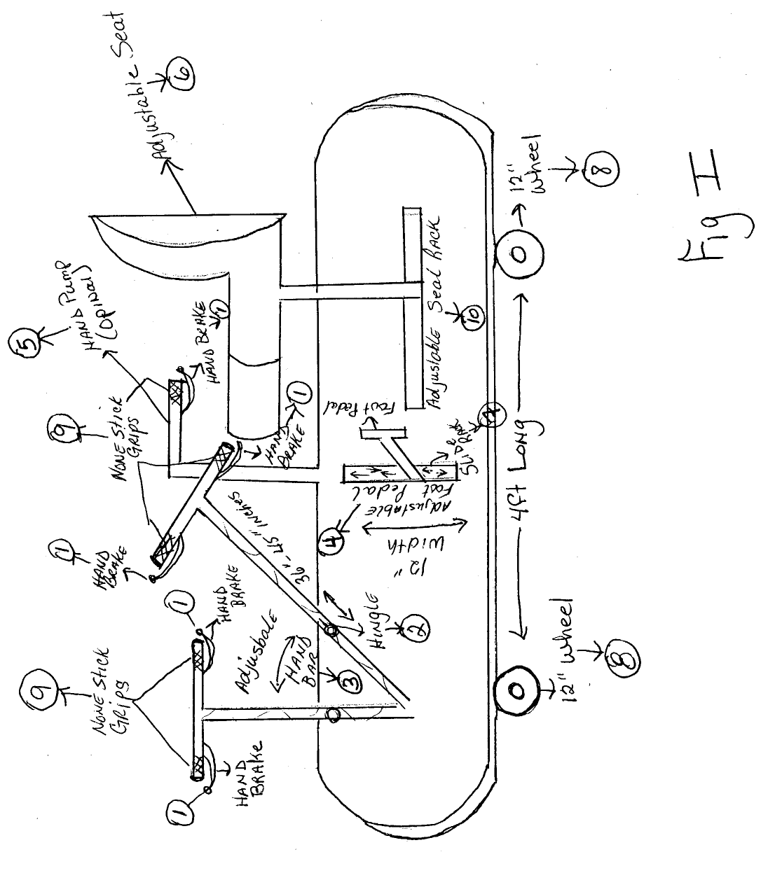

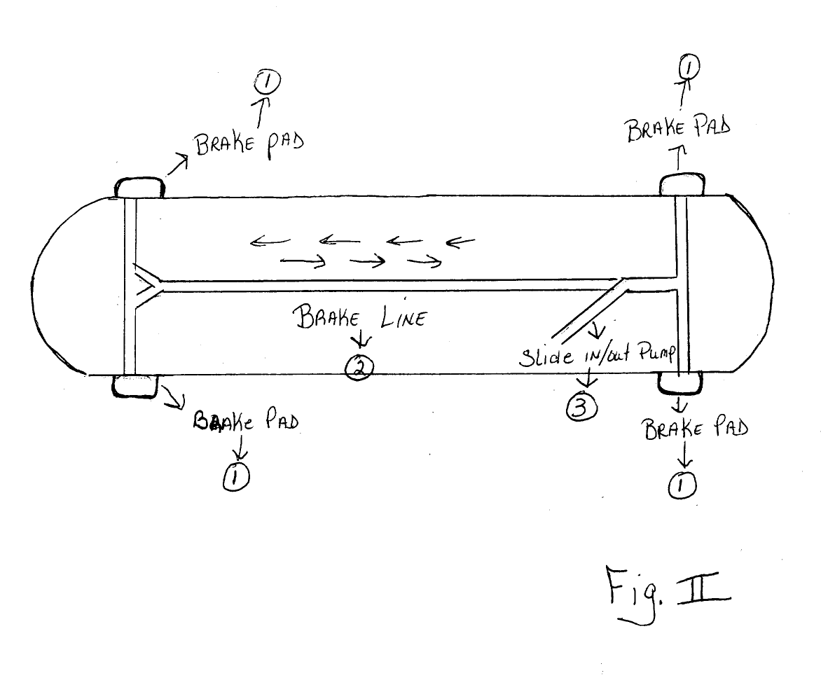

The concept of “Skascooter” would consist of a durable plastic scooter, measuring approximately 4 feet long and 1 foot wide. The unit would have a base platform with four mounted wheels measuring approximately 12 inches round. The front of the platform would feature a vertical pole and handlebars measuring approximately 30 to 45 inches high. The handlebar would be equipped with a hand brake. The handlebar could feature a folding hinge and locking mechanism to allow them to be extended approximately 18 inches backward for easy use while the rider is seated. The platform would also support a seat and petal mechanism. The pedal mechanism would be a lever or pedal assemblage that would engage the rear axle of the unit. This would provide a means of propelling the unit when the rider is seated.

### CROSS REFERENCE TO THE RELATED APPLICATIONS

N/A

### STATEMENT REGARDING FEDERALLY SPONSORED RESEARCH OR DEVELOPMENT

N/A

### REFERENCE TO A MICROFICHE APPENDIX

N/A

### BACKROUND OF THE INVENTION

In this portion, I will review the distinctive features of this invention. This is a fun and safe new type of riding scooter. The Skascooter would provide convenient fun for any scooter enthusiast. It would include a functional seat as well as a pedal mechanism, thus providing the rider with the option of sitting or standing, while propelling the scooter with one foot. This provides added flexibility to the design, thus making it ideal for individuals of all ages who enjoy riding scooters for fun and exercise.

### BRIEF SUMMARY OF THE INVENTION

This invention is a safe scooter. It stands by itself. It will not fall to the side. If you get tired of standing, you can sit down and pedal. Also, you have a brake.

### BRIEF DESCRIPTION OF THE SEVERAL VIEWS OF THE DRAWING

I.

1. Handle Brake

2. Hinge

3. Adjustable Handlebar

4. Adjustable Foot Pedal

5. Hand Pump (optional)

6. Adjustable Seat

7. Slide Rail

8. 12 inch Wheels

9. Non-Stick Grip

II.

1. Slide In/Out Pump

2. Brakes

3. Brake Line

### DETAIL DESCRIPTION OF INVENTION

It appears that Skascooter could be produced easily using conventional and readily available materials and manufacturing processes. No new production technology would be required.

The seat and accessories for the Skascooter could be produced from a plastic such as polystyrene. This material is readily available.

The frame of the Skascooter could be produced from a sturdy and lightweight metal such as stainless steel or aluminum.

The unit would measure 4 feet long and 1 foot wide. The unit would have base platform with four mounted wheels. It would have a vertical pole and handlebars measuring 30 inches high. The handlebars would be equipped with a hand brake. The brake would use a standard design and would utilize cables to apply pressure to the braking caliber on the wheels of the unit.

The platform would also support a seat and pedal mechanism. The seat would be produced from lightweight plastic and would be located approximately at the halfway point of the board. The handlebars would feature a folding hinge and lock mechanism to allow them to be extended 18 inches backward for easy use while the rider is seated.

The pedal mechanism, which is the most unique, would be a lever or pedal assemblage that would engage the rear axle of the unit. This would provide a means of propelling the unit when the rider is seated.

What I claim as my invention is a self-propelled scooter:

1. The pedal can be on either side of the scooter which would allow people who are right or left sided to use it effectively. Riders with certain restrictions could place it on their good side.
Also, it would help those who are paralyzed (in the leg) to fulfill the need to be independent and safe with the use of the extension bar on the pedal mechanism. The sturdy tip resistant design of the device could make it ideal for senior citizens who want to remain active and fit, but need to rest occasionally during an outing.
The Skascooter would also feature a longer and wider deck design than standard scooters. Thus, allowing two people, most likely children, to ride the scooter at the same time. This would be more appealing than riding a scooter alone.
